(19) United States
(12) Patent Application Publication
(10) Pub. No.: US 2024/0422131 A1
(43) Pub. Date: Dec. 19, 2024

(54) DEVICES, METHODS, AND GRAPHICAL USER INTERFACES FOR SECURELY CONNECTING TO COMMUNICATION NETWORKS

(71) Applicant: NOBLIS, INC., Reston, VA (US)

(72) Inventors: Ryan GUTHRIDGE, Aldie, VA (US); Hanim SONG, Chantilly, VA (US); Tyler W. BARRUS, Midlothian, VA (US)

(73) Assignee: NOBLIS, INC., Reston, VA (US)

(21) Appl. No.: 18/354,328

(22) Filed: Jul. 18, 2023

Related U.S. Application Data
(60) Provisional application No. 63/521,250, filed on Jun. 15, 2023.

(51) Int. Cl. H04L 9/40; H04W 48/04; H04W 48/06; H04W 48/16; H04W 48/20; H04W 64/00

(52) U.S. Cl. CPC H04L 63/0272; H04L 63/0428; H04W 48/04; H04W 48/06; H04W 48/16; H04W 48/20; H04W 64/003; H04W 88/06

(57) ABSTRACT

A system can include a router device in communication with a first wireless network interface; one or more sensors; and one or more processors. A location of the router device can be determined based on an output of the one or more sensors. It can be determined whether to establish a Wi-Fi network connection via the first wireless network interface. In accordance with a determination to establish a Wi-Fi network via the first wireless interface, a Wi-Fi network can be selected based on the location of the router device; a first VPN can be instantiated via the Wi-Fi network; and encrypted data can be communicated from a client device to the first VPN via the Wi-Fi network. In accordance with a determination not to establish a Wi-Fi network via the first wireless interface, an SIM can be selected from one or more SIMs based on the location of the router device; a connection to a cellular data network via a second wireless network interface can be initialized based on the selected SIM; a second VPN can be instantiated via the cellular data network; and encrypted data can be communicated from the client device to the second VPN via the cellular data network.

### CROSS-REFERENCE TO RELATED APPLICATION

This application claims the benefit of U.S. Provisional Application No. 63/521,250, filed Jun. 15, 2023, the entire contents of which are incorporated herein by reference.

### FIELD

Examples of the disclosure relate generally to systems and methods for connecting to computer networks, and more specifically, to systems and methods for using a router device to securely connect to a remote computer network using a virtual private network (VPN).

### BACKGROUND

Sensitive electronic data and sensitive electronic communications require secure and private network connections, even when accessing public networks from non-secure locations, such as when using public Wi-Fi connections or cellular connections. Known solutions for protecting and securing network communications do not address all needs, including the need for separating device-side network communications from public-network side network communications, the need for rapidly deploying ephemeral virtual private networks (VPNs) through which to route communications, the need to provide hotspot connectivity, the need to automatically cease network communications if it is detected that the VPN has gone down, and the need to provide a graphical user interface for controlling system functionality. Disclosed herein are systems and methods that may address one or more of the above-identified needs.

Disclosed herein is a device (and methods for use thereof) for facilitating secure network (e.g., wireless) communications, for example when using public Wi-Fi and/or cellular (e.g., 4G or 5G) connections. The device may be provided in the form of a secure travel router. The device may be provided as a SoC (System-on-Chip) board allowing for enormous flexibility in deployment options. For example, the device may be based on a Raspberry Pi. The device may include a user-side network communication interface, such as a Wi-Fi communication interface, other wireless communication interface, and/or wired communication interface. The device may include a separate, public-facing-side (e.g., network-side) network communication interface, such as a Wi-Fi communication interface, cellular communication interface, Ethernet communication interface, other wireless communication interface, and/or other wired communication interface. A user may connect their own mobile (e.g., phone or laptop) to the user-side communication interface, and may connect the network-side communication interface of the device to the public network. Network traffic may be passed on the device (e.g., using IP rules) between the two separate network communication interfaces.

The device may include instructions, for example instructions stored locally on memory on the device, for instantiating and configuring an ephemeral VPN, and for using said ephemeral VPN to transmit (and thereby protect) network traffic transmitted to and from the device. Thus, a secure tunnel for safe transport of wireless communications is provided. The VPN functionality allows users to be able to leverage an ephemeral VPN hosted at the service provider of their choosing and configured in a manner of their choosing.

The device may be configured to provide a software “kill switch” that monitors the status of the instantiated VPN and/or monitors traffic passing through the VPN and/or otherwise passing to/from the device. The device may be configured such that, if it is detected that the VPN connection is dropped (or if it is detected otherwise that the VPN has ceased functioning), then communications to/from the device are ceased such that no data leaves the device. The device may be configured to transmit instructions to destroy the VPN after use of it is complete.

The device may be configured to provide hotspot connectivity, such that one or more client devices (e.g., mobile devices) may connect to the device (e.g., using Wi-Fi) as a hotspot via the user-device-facing network communication interface. The device may be able to enter a “discoverable” mode where other client devices can discover it as a hotspot. The hotspot may be provided via the user-facing network communication interface of the device. The device may be configured to rapidly deploy ephemeral hotspots and to destroy the hotspots after use of them is complete.

The device may include a display (e.g., a touch-screen display) that provides a graphical user interface that allows users to control system functionality. The graphical user interface may allow users to interact with a plurality of screens (e.g., provided as toggle screens) to configure different device functionality. The graphical user interface may allow users to access Wi-Fi capture pages, such as those found in coffee shops and hotels, allowing users to easily connect the outbound network communication interface.

A Wi-Fi graphical user interface (GUI) screen may provide an affordance to cause the device to scan for Wi-Fi networks, an affordance allowing users to select from amongst detected Wi-Fi networks, a field allowing users to enter Wi-Fi passwords, an affordance to cause the device to connect to a selected Wi-Fi network, an affordance to cause the device to disconnect from a connected Wi-Fi network, and a GUI object displaying a status of the Wi-Fi connection. The Wi-Fi GUI may allow users to navigate web content, such as captive portals often used to access public Wi-Fi connections.

A VPN GUI screen may include an affordance allowing a user to select a configuration file (e.g., a PEM file), a field allowing a user to enter a network address at which to instantiate a VPN, an affordance to cause the device to create a VPN, an affordance to cause the device to destroy a VPN, an affordance to cause the device to restart a VPN, and a GUI object displaying a status of whether a VPN is deployed and/or functioning correctly.

A hotspot GUI screen may comprise an affordance allowing users to select from amongst different available network communication interfaces by which to provide hotspot connectivity, a field allowing users to input a hotspot name, a field allowing users to input a password for a hotspot to be deployed, an affordance to cause the device to create a hotspot, an affordance to cause the device to destroy a hotspot, and a GUI object displaying a status of whether a hotspot is currently deployed.

In some embodiments, the GUI may be user-editable.

The device may be small, portable, and/or battery-powered.

The devices disclosed herein provide a combination of multiple features into a single device, coupled with the simple deployment of a VPN solution to a service provider of the user's choosing, and further coupled with the assurance that no unsecured data ever leaves the hardware device. This combination of features is not provided in known solutions.

Any of the features disclosed herein, including any of the features disclosed in the claims, specification, and/or figures, may be combined in whole or in part with one another.

### SUMMARY

According to examples of the disclosure, a system can include a router device in communication with a first wireless network interface; one or more sensors; and one or more processors. A location of the router device can be determined based on an output of the one or more sensors. It can be determined whether to establish a Wi-Fi network connection via the first wireless network interface. In accordance with a determination to establish a Wi-Fi network via the first wireless interface, a Wi-Fi network can be selected based on the location of the router device; a first VPN can be instantiated via the Wi-Fi network; and encrypted data can be communicated from a client device to the first VPN via the Wi-Fi network. In accordance with a determination not to establish a Wi-Fi network via the first wireless interface, an SIM can be selected from one or more SIMs based on the location of the router device; a connection to a cellular data network via a second wireless network interface can be initialized based on the selected SIM; a second VPN can be instantiated via the cellular data network; and encrypted data can be communicated from the client device to the second VPN via the cellular data network.

### BRIEF DESCRIPTION OF THE DRAWINGS

FIG. 1 illustrates an example computer system for implementing various examples of the disclosure.

FIG. 2 illustrates an example computer system for implementing various examples of the disclosure.

FIG. 3 illustrates an example computer network in which a computer system communicates over the Internet via a VPN, according to examples of the disclosure.

FIGS. 4A and 4B illustrate example processes that a computer system can perform to communicate with a computer network according to examples of the disclosure.

FIGS. 5A, 5B, and 5C illustrate views of an example graphical user interface according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Example processes described herein can be performed or implemented via one or more computers, computing devices, or computing systems (including conventional computers and including mobile devices, such as smartphones). Examples of the disclosure may be implemented in any suitable form, including hardware, software, firmware, or any combination of these, using any suitable programming language or technology. Devices used to implement examples of the disclosure can include one or more processors (e.g., CPUs, GPUs, DSPs) configured to execute instructions stored on transitory or non-transitory computer-readable media, thereby performing one or more steps of one or more methods described herein. For example, computer-readable media can include optical media (e.g., CD-ROM, DVD-ROM, Blu-Ray, etc.); a memory; or any other medium capable of being accessed by a computer. Embodiments described herein can be implemented in any suitable format, including hardware or software in any suitable combination. A communications network (e.g., the Internet) can be used to communicate data between two or more elements or nodes of a system described herein, such as between two computers or other devices (e.g., smartphones or mobile devices). These communications can include communication via wired (e.g., Ethernet) or wireless (e.g., Wi-Fi, Bluetooth) communication channels and digital or in analog communication channels. Other suitable technologies for implementing the examples disclosed herein will be familiar to the skilled artisan and are within the scope of this disclosure.

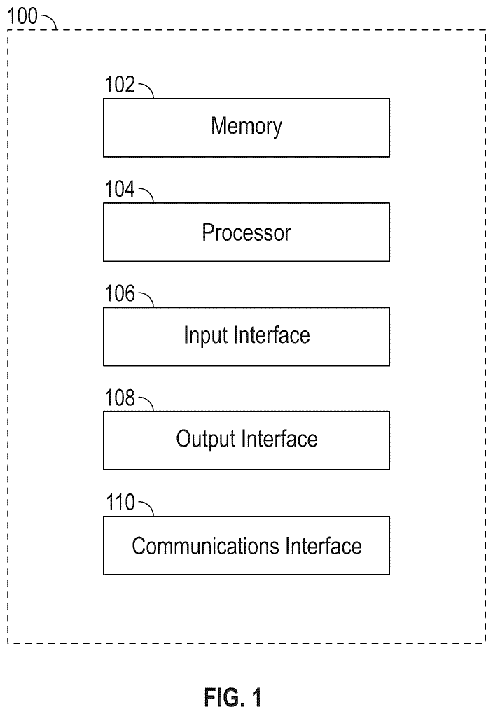

FIG. 1 illustrates an example computer system 100 such as described above. Computer 100 can be used to implement one or more of the example systems or methods described herein. As shown in the figure, the example computer 100 includes or communicates with one or more memories 102, one or more processors 104, one or more input interfaces 106, one or more output interfaces 108, and one or more communications interfaces 110. Memory 102 may include volatile storage (e.g., random access memory (RAM)) and non-volatile storage (e.g., read only memory (ROM) of a hard disk). Non-volatile storage can include application programs and/or an operating system. In some examples, the systems and methods described herein may be implemented via application programs executing on a server and/or a client device. Processor 104 can include any suitable processor or processors (e.g., one or more CPUs, GPUs, DSPs) for executing instructions, such as instructions stored in memory 102. Input interface 106 may include any suitable interface to computer system 100, such as a keyboard, mouse, touch screen, camera, microphone, sensor, or biometric device. Output interface 108 may include any suitable output device for computer 100, such as a conventional display (e.g., a conventional television or computer monitor), a printer, or a head-worn virtual reality or augmented reality display. Communications interface 110 can allow communication between devices or nodes on a network, such as described above. In some examples, the memory 102, processor 104, input interface 106, output interface 108, and communications interface 110, or any suitable combination of the above, can be interconnected by a bus. The skilled artisan will appreciate that the above description of an example computer system 100 is non-limiting and that any suitable component, technology, or combination of the above for computer system 100 is within the scope of the disclosure. Further, the skilled artisan will appreciate that example computer system 100 may include multiple devices implementing one or more of the above features. For example, as described further herein, examples of computer system 100 can include a first device (e.g., a router) in communication with a second device (e.g., a smartphone, server, or personal computer); each of the first device and the second device may include one or more of memory 102, processor 104, input interface 106, output interface 108, and communications interface 110. For example, computer system 100 can include a router that includes a memory, processor, input interface, output interface, and communications interface; and a smartphone that includes a memory, processor, input interface, output interface, and communications interface. In some examples, computer system 100 can include a single device, such as an all-in-one device, that includes one or more of memory 102, processor 104, input interface 106, output interface 108, and communications interface 110.

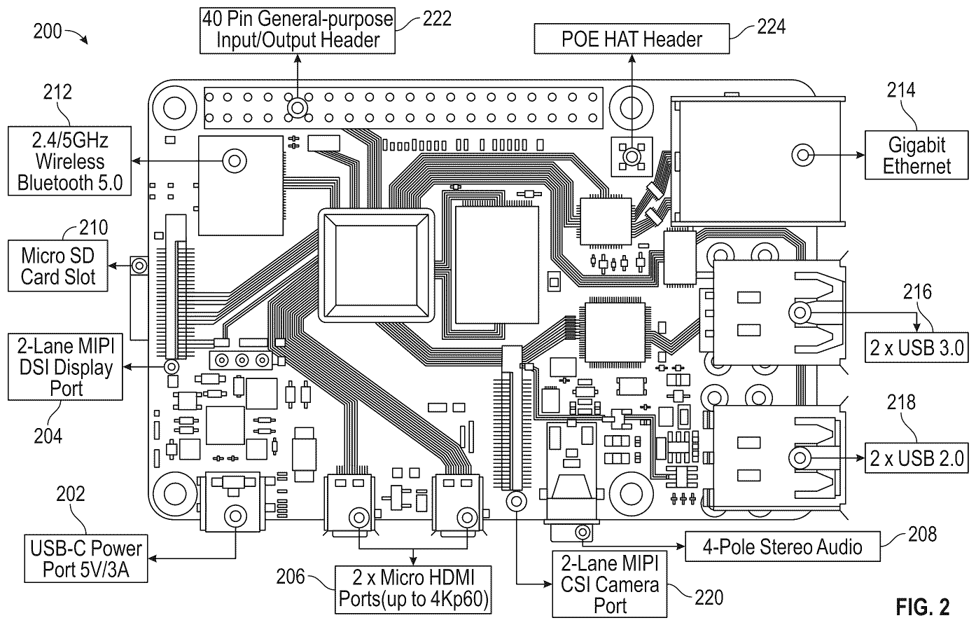

FIG. 2 illustrates an example router device 200 that can be used to implement one or more of the example systems or methods described herein. Router device 200 can be an example of computer system 100 described above, or a component of computer system 100; or can be configured to communicate with or interface with computer system 100. In some examples, router device 200 can be a portable device, and can be considered an “all-in-one” device that can operate on a standalone basis. In some examples, router device 200 can communicate with a second device, such as a smartphone, which can act as a host device and can provide one or more features described above for computer system 100. For instance, a smartphone can provide a communications interface to the Internet (e.g., via a wireless modem), and router device 200 can communicate via the Internet using the smartphone's communications interface. A smartphone (or other device) can also provide the router device 200 with access to input devices (e.g., keyboards or touch panels), displays (e.g., touch screens), data storage (e.g., flash memory), software, or processing capability (e.g., processors such as CPUs or GPUs).

In FIG. 2, some example features of router device 200 are shown. Router device 200 can include a memory (such as memory 102 described above) and one or more processors (such as processors 104 described above) such as to execute instructions stored on the memory. Router device 200 can include a power supply and/or power port 202 to provide power (e.g., a 5 VDC supply voltage, or another suitable supply voltage) to router device 200. In some cases, power can be provided via USB, USB-C, Micro-USB, or another suitable connector or protocol. The power supply may be internal or external (e.g., via an external power adapter) to router device 200. In some examples, the power supply can comprise an uninterruptible power supply (UPS). In some examples, an internal or external battery can be used to provide power via 202 to router device 200. Router device 200 can include interfaces to internal or external displays. For example, display port 204 can connect to an external display (e.g., a TV or computer monitor) via the MIPI Alliance Display Serial Interface (MIPI DSI), or a comparable interface, to present video output to the display. And display ports 206, which may include HDMI, mini HDMI, micro HDMI, or USB-C ports, can similarly connect to an external display. In some examples, video output may be provided to an integrated or onboard display, such as an integrated touch screen. In some examples, video output can be provided at 4K resolution and at 60 frames per second; however, other suitable resolutions and frame rates can be used. An audio interface 208 can provide audio input and/or output (e.g., 4-pole stereo audio). Router device 200 can also include onboard storage, such as a hard drive or flash memory, or can include an interface 210 to external storage, such as a Micro SD card or other removable storage media. A wireless communications interface 212 can provide wireless communications functionality, such as Bluetooth or Wi-Fi connectivity to send and receive data. For example, wireless communications interface 212 can include a Bluetooth module, a mesh network module, a Wi-Fi adapter (e.g., for 2.4/5 GHz Wi-Fi connectivity), and/or a cellular modem (e.g., to provide cellular communications via 4G LTE, 5G, or any other suitable communications standard). A wired communications interface 214 can include an Ethernet adapter (for, e.g., Gigabit Ethernet) or any other suitable interface for wired networking. In some cases, wired communications interface can supply power to router device 200 via Power over Ethernet (POE). Router device 200 can also include various I/O interfaces. For example, USB interfaces 216 and 218 can interface with devices using the USB 2.0 or USB 3.0 standards. A camera port 220 can be used to interface with a camera or image sensor via the MIPI Alliance Camera Serial Interface (MIPI CSI). I/O pins 222 (which may be general purpose I/O pins) can send and receive input and output from various peripherals or external devices. HAT (Hardware Attached on Top) header 224 can be used to connect to and communicate with one or more external peripherals (such as a Raspberry Pi HAT) to router device 200, expanding functionality. In some cases, power can be supplied to or from external peripherals via PoE. Communications interfaces 212 and 214, or any of the above I/O interfaces, can be used as device-side or user-facing communications interfaces (for instance, so that a client device can connect to router device 200 via the interface); and/or as network-side or public-facing communications interfaces (for instance, so that router device 200, and any connected client devices, can connect to a public network such as the Internet). In some examples, input from an input device (e.g., a keyboard or touch screen) can be provided via USB interfaces 216 or 218, camera port 220, I/O pins 222, HAT header 224, or an integrated input device. In some examples, input can be received via one or more sensors via USB interfaces 216 or 218, camera port 220, I/O pins 222, HAT header 224, or an integrated sensor. The one or more sensors can include, e.g., a location sensor (e.g., a GPS unit), a camera, a microphone, a biometric sensor (such as a fingerprint scanner or an iris scanner), a structured light sensor (e.g., a LIDAR unit), an infrared sensor, an optical sensor, a magnetic sensor, an acoustic sensor (e.g., a sonar unit), or any other suitable sensor or combination of sensors.

Router device 200, or another component of computer system 100, can include or communicate with a SIM (Subscriber Identity Module) for access to a data network, such as a cellular data network. The skilled artisan will be familiar with SIM technology, which is described for example in Andrew Tanenbaum, COMPUTER NETWORKS, 6th Ed. (2021). The SIM can be associated with a data service provider, such as a provider of a cellular data plan, and with a user or subscriber of that data service. The SIM can specify functionality, settings, permissions, or parameters associated with the user, the provider, or the data service; and the SIM can be used to initialize data services for the user via the provider. As the skilled artisan will recognize, a SIM as used herein can be a physical SIM card; an eSIM (embedded-SIM), which can comprise software installed onto a device (such as a mobile phone); or any other suitable SIM device. While the disclosure is not limited to any particular SIM format, the eSIM format can be advantageous in that a device can easily switch between multiple eSIMs for access to different data networks, or for access via different data service providers, without having to remove or manipulate a physical SIM card. However, physical SIM cards can be advantageous in that they can be easily relocated between devices, can be supported by legacy technology, and may be easier to integrate in some systems. In some examples, router device 200 can include one or more SIMs (e.g., multiple physical SIM cards). In some examples, router device 200 can communicate with an external module, such as an LTE HAT in communication with router device 200 via HAT interface 224, where the external module utilizes a physical SIM card or an eSIM to connect to a data network. In some examples, a mobile phone (or another communications device) in communication with router device 200 can include one or more SIMs, which can be used for the mobile phone to initialize data services via a data service provider.

In the example shown in FIG. 2, a single-board computer such as a Raspberry Pi can be used to implement router device 200. Devices such as the Raspberry Pi can provide, e.g., one or more processors (e.g., one or more CPUs or GPUs); memory; non-volatile storage; a communications interface (e.g., an Ethernet adapter or wireless modem); an input device; or any combination of the above. In some cases, an operating system and/or application software can be provided for execution by the one or more processors. However, the skilled artisan will understand that many different devices and components can be used to implement router device 200. For example, router device 200 can be implemented using a desktop or laptop computer; a smartphone or tablet; or another suitable device. The skilled artisan will understand that the router device 200 can include any of the functionality, including any hardware functionality and software functionality, provided by any of these computing devices.

It is advantageous for computer system 100 to include a portable device (e.g., router device 200) that can connect securely from a field location to a remotely located computer network. For example, it is advantageous for router device 200 to securely connect from the field location to one or more networked computers of a corporate headquarters (which can in turn be securely connected to one or more networked computers of a satellite office). In some cases, the field location and the remote computer network may be located in different countries; different regions of the same country; or different areas of the same geographic region. A field location in which the portable device is located may have communication needs, concerns, or preferences that are based on that location. For example, the portable device may be located in a location in which network communications are monitored or under surveillance; in which network infrastructure has been compromised; in which devices must comply with specific regulatory requirements, usage restrictions, or other limitations (e.g., privacy restrictions); or in which data bandwidth, power, or other resources are limited. In some cases, a user of the portable device may prefer a particular data service provider (such as a cellular service provider or an Internet service provider (ISP)) for network access (e.g., Internet access) based on the location of the portable device. For example, the user may prefer to use a first service provider (e.g., Company A) for cellular service in the United States, but to use a second service provider (e.g., Company B) for cellular service in Mexico. This preference may be based on considerations such as a provider's rates, coverage area, quality of service, data policies, privacy policies, or usage policies in a particular location. For instance, Company A may offer more reliable coverage than Company B in a first location (which can be a country, a city, a state, a building, a room, a neighborhood, a time zone, a continent, a range of latitudes and longitudes, a range of GPS coordinates, a zone or subnetwork of a computer network, or any other suitable location or type of location), such that Company A is preferred for data service when the portable device is in the first location. But Company B may offer more economical pricing, or greater data security, or some other advantage, such that it is preferred when the portable device is in the second location (or a location different from the first location).

Router device 200 can make use of a virtual private network (VPN) to communicate securely with a remote computer network via an unsecured network, such as the public Internet (which may be accessed by, e.g., publicly available Wi-Fi, or cellular service provided by an untrusted entity). A VPN is an overlay network on top of a public data network that has properties of a private network, such as a network built up from company computers and leased telephone lines. As the skilled artisan will understand, VPN can maintain an authenticated, encrypted, communications channel for securely transmitting data traffic across a public network, such as the Internet. The skilled artisan will be familiar with such VPNs, which are described for example in Andrew Tanenbaum, COMPUTER NETWORKS, 6th Ed. (2021). A VPN can be an ephemeral VPN. For example, a VPN can be configured to automatically terminate once certain conditions are met. The VPN can be configured to terminate once a time limit or a data limit has been reached; when a particular user or device disconnects from the VPN; when the VPN is no longer in use or is no longer needed; when an authentication challenge fails; when suspicious network behavior is detected; and/or when other suitable conditions are met. Such ephemeral VPNs can enhance network security, particularly in untrusted network environments, by placing automatic restrictions on access to the VPN.

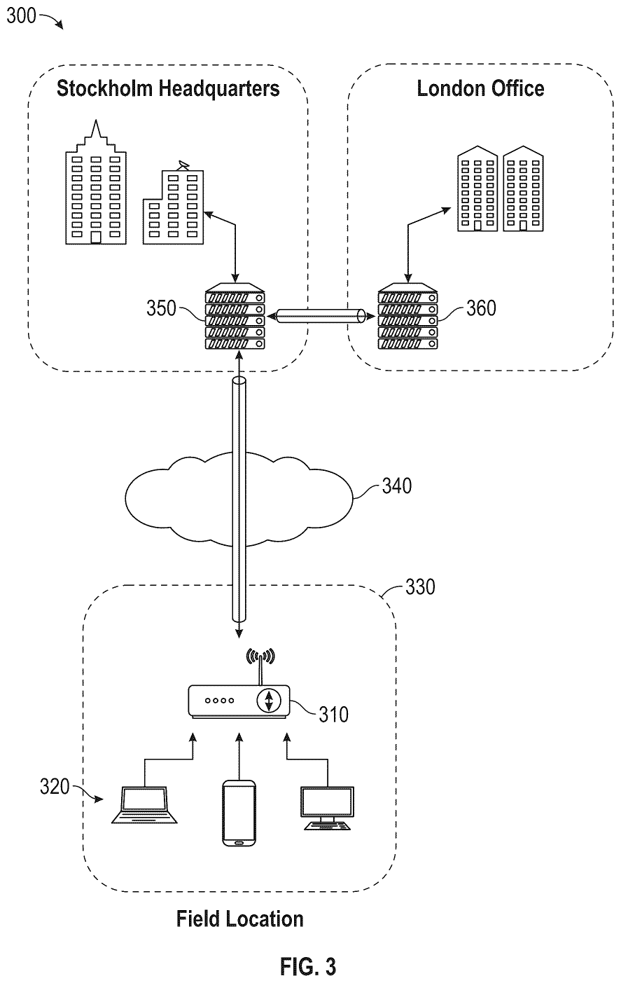

FIG. 3 illustrates an example computer network 300 in which a computer system communicates over the Internet via a VPN. In computer network 300, computer system 310 (which can correspond to computer system 100 and/or router device 200 described above) is in communication with one or more client devices 320, such as via network interface 212 or 214 described above. Client devices 320 can include one or more of a laptop computer, a desktop computer, a mobile phone, a tablet, a game console, or any other suitable device that can send and/or receive data via a computer network. In the example shown, computer system 310 and client devices 320 are located at a field location 330. Field location 330 can correspond to a country, a city, a state, a building, a room, a neighborhood, a time zone, a continent, a range of latitudes and longitudes, a range of GPS coordinates, a zone or subnetwork of a computer network, or any other suitable location or type of location. As shown in the example, computer system 310 and client devices 320 communicate with a remote headquarters in Stockholm, over the internet 340, by sending and receiving data to and from a VPN server 350 that implements a VPN. (While VPN servers are shown in the example, other VPN implementations that may not include VPN servers are within the scope of the disclosure.) The data typically is end-to-end encrypted and communicated between computer system 310 and VPN server 350 by tunneling (e.g., via the IPSec protocol). As shown in the figure, client devices 320 can securely send and receive data from the field location 330 to the Stockholm headquarters by sending and receiving the data to computer system 310, which securely sends and receives the data to the VPN server 350. VPN server 350 can, in turn, communicate securely with other VPN servers of the VPN, such as a VPN server 360 associated with a London office. In some examples, the VPN can be an ephemeral VPN, such as described above.

In some examples, computer system 310 can communicate with a VPN (e.g., via VPN server 350) using a wired or wireless communications interface, such as interfaces 212 or 214 described above. For example, computer system 310 can use a Wi-Fi adapter to connect to the Internet 340 and communicate with VPN server 350. In some examples, computer system 310 can communicate with VPN server 350 via a mobile phone, or via another device with a cellular data communications interface (e.g., a 4G LTE or 5G modem or HAT). In some such examples, a device such as router device 200 can tether to the mobile phone to take advantage of the mobile phone's existing cellular connectivity, and can send and receive data to VPN server 350 by using the mobile phone as an intermediary. Similarly, client devices 320, in communication with router device 200, can send and receive data to VPN server using the mobile phone. In some cases, the VPN is created by (and may be terminated by) computer system 100, router device 200, and/or the mobile phone or cellular data device.

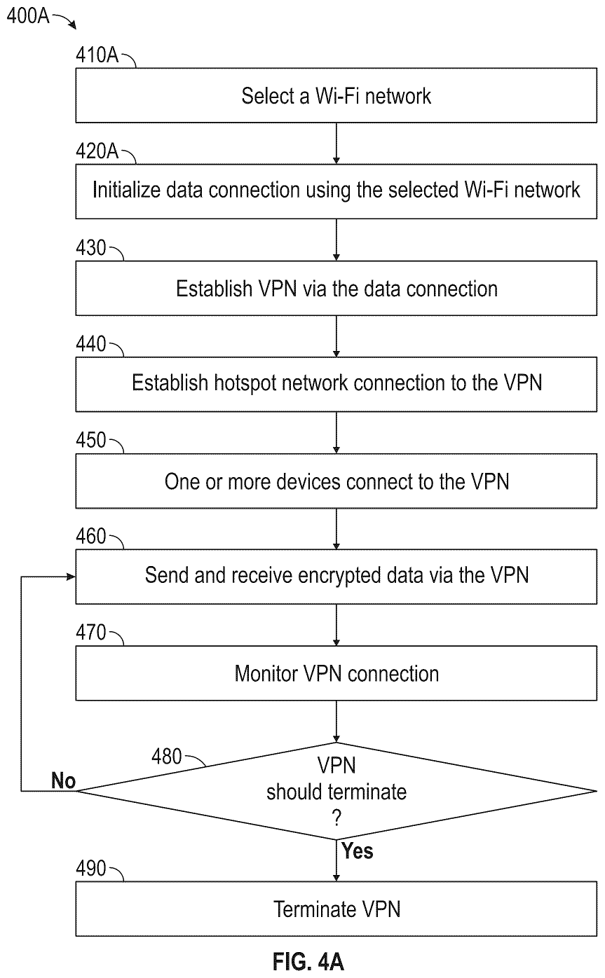

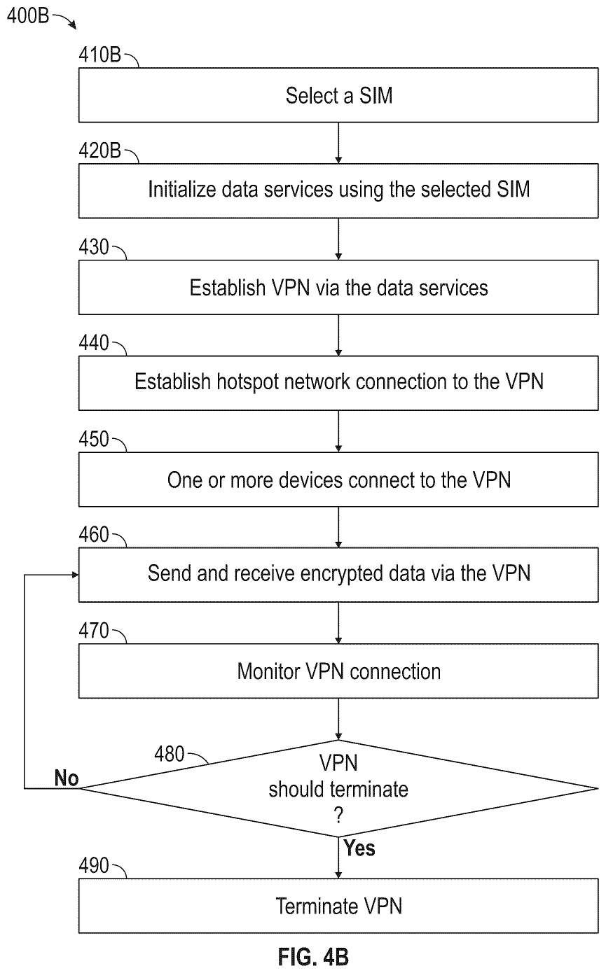

FIGS. 4A and 4B show example processes 400A and 400B, respectively, that a computer system 100 (such as a computer system including router device 200) can use to communicate with a computer network. Process 400A is an example in which computer system 100 communicates with the computer network via a Wi-Fi connection; and process 400B is an example in which computer system 100 communicates with the computer network via a cellular data network. One or more steps of process 400A or 400B can be performed by processors 104 of computer system 100, which may include one or more processors of router device 200, or one or more processors of a device (such as a mobile phone, or a HAT with cellular connectivity) in communication with router device 200, such as described above. Computer instructions for performing process 400A or 400B can be stored in memory 102 of computer system 100, which may include a memory of router device 200 or a memory of a device (such as a mobile phone or HAT) in communication with router device 200, such as described above.

At stage 410A of process 400A, a Wi-Fi network can be selected from a group of available Wi-Fi networks. In some examples, the Wi-Fi network can be selected based on one or more attributes of the Wi-Fi network, such as a security policy of the Wi-Fi network; whether the Wi-Fi network is public or private; a connection quality of the Wi-Fi network; or other suitable attributes. At stage 420A of process 400A, a data connection (e.g., to the Internet) can be initialized using the selected Wi-Fi network according to techniques known in the art. In some examples, user input received via a GUI, such as presented via a display in communication with computer system 100, can be used to select the Wi-Fi network and to initialize the data connection. In some examples, these operations can be performed automatically.

At stage 430 of process 400A, a VPN can be instantiated using the data connection initialized at stage 420A, according to techniques known in the art. For example, VPN utilities (such as WireGuard) familiar to the skilled artisan can be used to instantiate and configurate the VPN for use by computer system 100. In some cases, the VPN can be an ephemeral VPN such as described above, and stage 430 can include configuring ephemeral features of the VPN, such as conditions (e.g., time limits or other conditions described above) under which the VPN will automatically terminate. In some examples, a configuration file, such as a PEM file, can be stored in memory of computer system 100 and can be used to instantiate and configure the VPN. For example, the configuration file can retain settings associated with the VPN, so that the computer system 100 can utilize the same or analogous settings for future VPN connections. In some cases, the configuration file, or other VPN setup and configuration information, can be pre-loaded in memory of computer system 100.

At stage 440 of process 400A, a network connection for other devices (e.g., client devices) can be established using the VPN and the initialized data connection. For example, a wireless hotspot can be established using router device 200, according to techniques known in the art, to provide client devices (e.g., mobile phones, tablets, laptop computers, smart home devices, game consoles, etc.) with access to the VPN via the hotspot. For example, at stage 450 of process 400, such client devices can connect to the hotspot of router device 200 via a network adapter (e.g., a wired Ethernet adapter or a Wi-Fi adapter), and send and receive data via the VPN (stage 460) using the router device 200. In some examples, such as where computer system 100 includes a mobile phone, the hotspot can be established at stage 440 using the mobile phone, and client devices can connect to the VPN via the mobile phone at stage 450, such that the client devices can send and receive data via the VPN at stage 460.

At stage 470 of process 400A, a status of the VPN connection can be monitored. For example, the status of the VPN connection can be monitored to determine whether a connection to the VPN has been lost, or whether a fault has occurred, e.g., whether the connection has been interrupted or compromised, such that communications via the VPN are no longer secure. The VPN status can be monitored and managed locally to the VPN (e.g., at a VPN server location or another location of the VPN) and/or remotely (such as at a location of remote device 200, or at another remote location). In some examples, monitoring and management can be performed by remote device 200, and/or by a VPN server (e.g., VPN server 350). In some examples, a GUI can be used for VPN monitoring and management, as described below. At stage 480, it can be determined whether the VPN should be terminated based on the status of the VPN connection, based on the monitoring and management of the VPN such as described above, or for any other reason (e.g., to minimize power consumption or bandwidth, or as a timeout for security reasons). In some examples, a user can direct computer system 100 to terminate the VPN, such as by providing input via a GUI presented on a display. If it is determined at stage 480 that the VPN should terminate, the VPN can be so terminated at stage 490. Otherwise, process 400A can continue to send and receive encrypted data via the VPN, such as described above for stage 460.

In some cases, if the VPN is terminated or if a VPN connection is otherwise lost, process 400A can immediately terminate the Wi-Fi network connection; terminate the hotspot; disconnect from one or more client devices; turn itself off; or take other measures to ensure that no data is sent or received via the network connection. This can be advantageous in high-risk environments, such as military environments, or in communications involving highly sensitive data, by providing safeguards against accidentally transmitting data without the security offered by the VPN. In some instances, an alarm or alert notification can be triggered in accordance with terminating the VPN or with a lost VPN connection.

With respect to process 400B, at stage 410B, a SIM can be selected from one or more SIMs. (As described above, a SIM as used herein can refer to a physical SIM card, an eSIM, or another suitable device.) In some examples, the one or more SIMs may include a group of 15 to 20 different SIMs. As described above, a SIM can include subscriber information or access information for a data network, such as information identifying a data plan. A SIM can be selected from one or more SIMs based on a preference, requirement, or consideration for data access based on the current location of the router device 200. For example, as described above, a first data plan or data service provider associated with a first SIM may be preferred if the current location is a first location (e.g., a location within the United States); and a second data plan or data service provider associated with a second SIM may be preferred if the current location is a second location (e.g., a location within Mexico). As described above, this preference may be based on considerations such as a provider's rates, coverage area, quality of service, data policies, privacy policies, or usage policies in a particular location. For instance, a first service provider may offer more reliable coverage than a second service provider in a first location (which can be a country, a city, a state, a building, a room, a neighborhood, a time zone, a continent, a range of latitudes and longitudes, a range of GPS coordinates, a zone or subnetwork of a computer network, or any other suitable location or type of location), such that the first service provider is preferred for data service when the portable device is in the first location. But the second service provider may offer more economical pricing, or greater data security, or some other advantage, such that it is preferred when the portable device is in the second location (or a location different from the first location).

At stage 420B of process 400B, data services can be initialized using the selected SIM. For example, computer system 100 can communicate information from the selected SIM to a data service provider in order for the data service provider to permit computer system 100 to send and receive data via the data service provider's network. This initialization process may depend on the specific SIM selected, or on the data service provider associated with that selected SIM. For example, initializing data service with a major cellular service provider (e.g., Verizon, AT&T) may be a relatively lengthy process that exchanges a relatively large amount of data (potentially including personal information) between computer system 100 and the service provider. But initializing data service with a different or smaller service provider (e.g., Airalo, Holafly) may be a shorter and faster process that exchanges a smaller amount of data or a different type of data. In some cases, it can be advantageous to select an SIM that is associated with a particular initialization process. Thus, in some examples, the SIM can be selected at stage 410B based at least in part on an initialization process associated with that SIM. For instance, if computer system 100 is in a low-bandwidth network environment, or if computer system 100 is in a location in which certain information should not be transmitted as part of an initialization process, then an SIM can be selected such that an initialization process at stage 420B is a faster initialization process or a reduced data transmission initialization process. As one example, a first SIM (e.g., corresponding to a major cellular service provider) can be selected if computer system 100 is in a residential home environment; and a second SIM (e.g., corresponding to a smaller service provider) can instead be selected if computer system 100 is in hostile territory in a military environment. In some examples, one or more of the SIMs may be stored in, or otherwise associated with, a mobile phone in communication with router device 200.

Stages 430 through 490 of process 400B are analogous to stages 430 through 490 described above for process 400A, except that data communicated in process 400B is communicated via the cellular data network via data services established in process 400B (such as described above for stages 410B and 420B).

In some examples, one or more processors may execute process 400A or 400B based on a determination whether a cellular data network should be used for network communications, or on a determination whether a Wi-Fi network should be used for network communications. For example, computer system 100 can determine whether one or more public Wi-Fi networks are available. If one or more public Wi-Fi networks are available, computer system 100 can determine that a Wi-Fi network should be used for communication, and can perform process 400A, e.g., by using a Wi-Fi adapter to connect to the Wi-Fi network and initialize data services, as described above for stages 410A and 420A. But if no public Wi-Fi networks are available, computer system 100 may instead perform process 400B, e.g., by selecting a SIM and initializing data services using the selected SIM, as described above for stages 410B and 420B. In some examples, computer system 100 can determine whether a Wi-Fi network should be used based on a location (e.g., a country) of computer system 100, based on a characteristic of available Wi-Fi networks, or other suitable factors. In some examples, computer system 100 can determine that a cellular data network should be used for network communications based on a determination that a Wi-Fi network should not be used. In some cases, computer system 100 can establish a wired or wireless communication with a mobile phone, or another device (such as a peripheral connected to router device 200 via HAT interface 224), and use a wireless network interface of the mobile phone or device to connect with the cellular data network, such as described above for process 400B.

In some examples, one or more steps of process 400A or 400B described above may be performed at the direction of a user of computer system 100, such as in response to a command provided by the user via a GUI and an input device in communication with computer system 100. The GUI can be presented to the user via a display (such as a touch screen, computer monitor, or head-wearable display) in communication with computer system 100 and configured to receive output display data from computer system 100. The GUI can also be configured to receive user input (e.g., via a touch screen or touch panel, mouse, keyboard, or other input device) and to communicate the user input to a processor of computer system 100. A GUI can include one or more user-interactable interface elements, such as buttons, icons, switches, sliders, text entry boxes, menus, or other suitable elements. In some examples, elements of a GUI can be configured by a user; for instance, a user can choose to selectively show or hide one or more elements of a GUI, or can create custom GUI elements. Moreover, in some instances, a user can configure a script to execute in response to an interaction with a user interface element. In some examples, the input and output of the GUI can be handled via an operating system (such as Linux (e.g., Debian), Unix, Raspberry Pi OS, Windows, iOS, or Android) executing on a processor of computer system 100.

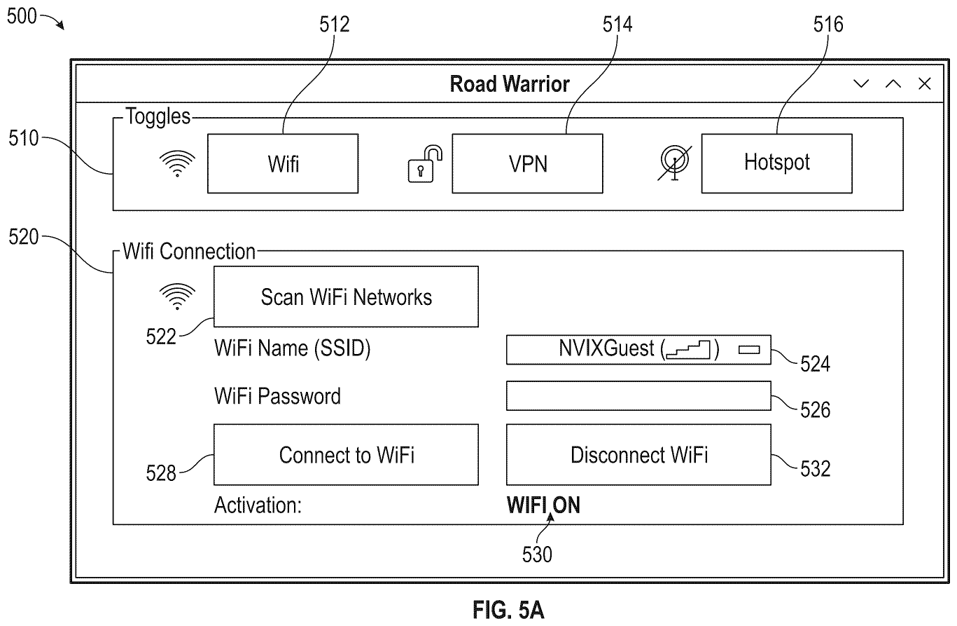

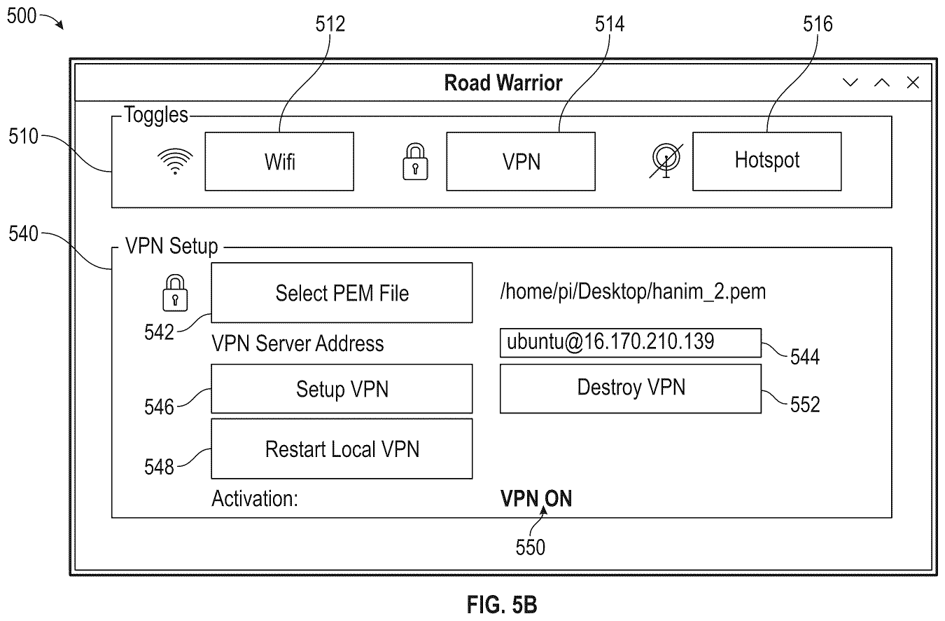

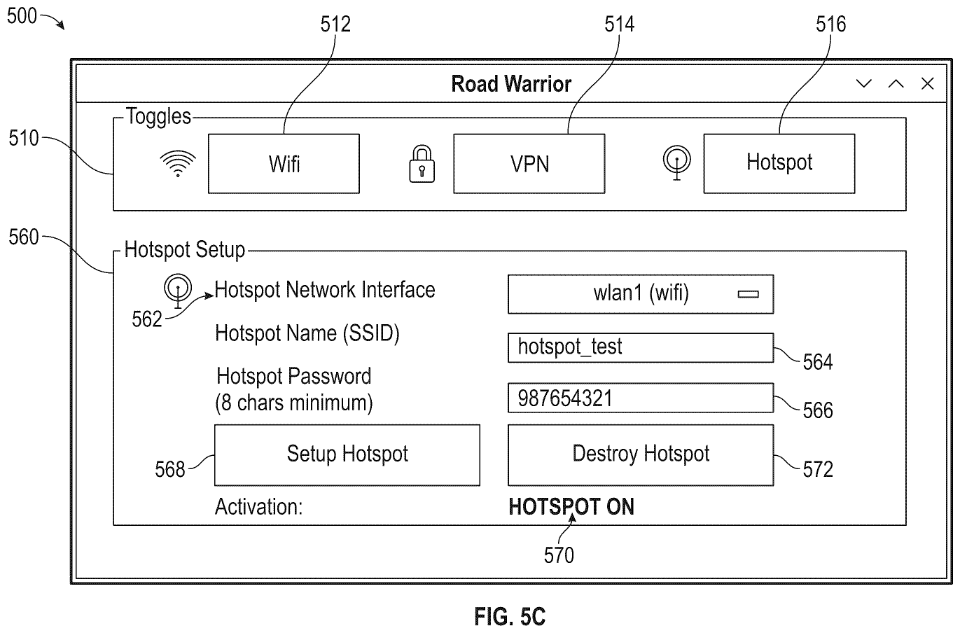

FIGS. 5A, 5B, and 5C present views of an example GUI 500 via which a user can interact with computer system 100. As illustrated in FIGS. 5A, 5B, and 5C, GUI 500 can include one or more interface elements 510, which may correspond to various functionalities of computer system 100. Interface elements 510, or other elements of GUI 500, can be associated with one or more steps of example processes 400A or 400B, described above. In the example shown, interface elements 510 include Wi-Fi button 512, which can be clicked to present Wi-Fi functionality via GUI 500; VPN button 514, which can be clicked to present VPN functionality via GUI 500; and hotspot button 516, which can be clicked to present hotspot functionality via GUI 500. (The skilled artisan will appreciate that, with respect to FIGS. 5A, 5B, and 5C, the interface elements (e.g., buttons), interactive behaviors (e.g., clicking), labels, and graphical arrangements shown are illustrative, and that other suitable elements, behaviors, labels, and arrangements, and other aspects of the user interface, are within the scope of the disclosure.)

In the example view shown in FIG. 5A, GUI 500 presents Wi-Fi related interface elements 520. Elements 520 can be shown or hidden in response to a user clicking Wi-Fi button 512. In the example, a user can click on a Scan Wi-Fi Networks button 522 to search for and display (via menu 524) a list of available Wi-Fi networks. A user can use menu 524, a password entry field 526, and a Connect to Wi-Fi button 528 to select and connect to a Wi-Fi network. Some or all of the above operations can be performed as part of stage 410A of process 400A, described above. A status indicator 530 can present a status of the Wi-Fi connection (e.g., “Wi-Fi On” or “Wi-Fi Off”). A Disconnect Wi-Fi button 532 can be engaged to disconnect from the Wi-Fi network, such as described above with respect to stage 490 of process 400A. In some examples, GUI 500 can include or interface with a web browser for interacting with websites or web-based interfaces. For example, connecting to a Wi-Fi network via GUI 500 may initiate a web-based interface, such as a captive portal, in which to provide login credentials for the Wi-Fi network; in response, GUI 500 can present a web browser to display the web-based interface, and to accept user input for engaging with the web-based interface and providing the login credentials.

In the example view shown in FIG. 5B. GUI 500 presents VPN-related interface elements 540. Elements 540 can be shown or hidden in response to a user clicking VPN button 514. In the example, a user can click on button 542 to select a VPN configuration file, such as a PEM file described above, which can load VPN connection settings for initiating and configuring a VPN. A user can use a VPN Server Address field 544 to manually enter a VPN server address, and can interact with a Setup VPN button 546 to set up a VPN (e.g., based on information in the VPN configuration file, or based on a VPN server address entered manually). Similarly, a Restart Local VPN button 548 can be used to restart the VPN, such as in response to a change in configuration settings. Some or all of the above operations can be performed as part of stage 430 of processes 400A and 400B, described above. A status indicator 550 can present a status of the VPN (e.g., “VPN On” or “VPN Off”), such as described above for stage 470 of processes 400A and 400B. In some cases, status indicator 550 can present detailed VPN information, such as connection metrics, security information, or fault detection information. In some examples, this VPN information can be used at stage 480 of processes 400A or 400B to determine whether the VPN should be terminated (stage 490). A Destroy VPN button 552 can be engaged to terminate the VPN, such as described above with respect to stage 490 of processes 400A and 400B.

In the example view shown in FIG. 5C, GUI 500 presents hotspot-related interface elements 560. Elements 560 can be shown or hidden in response to a user clicking hotspot button 516. In the example, a user can click on a Hotspot Network Interface menu 562 to select a hotspot network interface, such as a Wi-Fi network selected at stage 410A of process 400A, or a cellular data network associated with a SIM selected at stage 410B of process 400B. A user can use a Hotspot Name entry field 564 and a Hotspot Password entry field 566 to assign SSID and password data, respectively; and can engage with a Setup Hotspot button 568 to establish a hotspot, via the selected network interface, with the entered SSID and password data. This can be performed as part of stage 440, described above for processes 400A and 400B. Client devices can use the SSID and password to connect to the hotspot (such as described above for stage 450 of processes 400A and 400B) and exchange data with the VPN (stage 460). A status indicator 570 can present a status of the hotspot (e.g., “Hotspot On” or “Hotspot Off”). In some cases, status indicator 570 can present detailed hotspot information, such as network data, activity logs, or identifying information for client devices connected to the hotspot. A Destroy Hotspot button 572 can be engaged to terminate the hotspot, such as described above with respect to stage 490 of processes 400A and 400B (in which the hotspot may be terminated in accordance with a determination that the VPN is compromised or should be terminated).

According to some examples of the disclosure, a system can comprise a router device in communication with a first wireless network interface; one or more sensors; and one or more processors configured to perform a method comprising: determining, based on an output of the one or more sensors, a location of the router device; determining whether to establish a Wi-Fi network connection via the first wireless network interface; in accordance with a determination to establish a Wi-Fi network connection via the first wireless interface: selecting a Wi-Fi network based on the location of the router device; instantiating a first virtual private network (VPN) via the Wi-Fi network; and communicating encrypted data from a client device to the first VPN via the Wi-Fi network; and in accordance with a determination not to establish a Wi-Fi network connection via the first wireless interface: selecting, based on the location of the router device, a SIM from one or more SIMs; initializing, based on the selected SIM, a connection to a cellular data network via a second wireless network interface; instantiating a second VPN via the cellular data network; and communicating encrypted data from the client device to the second VPN via the cellular data network. In some examples, selecting the SIM from the one or more SIMs is based on a bandwidth restriction associated with the location of the router device. In some examples, the selecting the SIM from the one or more SIMs is based on a data policy associated with the location of the router device. In some examples, the selecting the SIM from the one or more SIMs comprises selecting a first SIM in accordance with a determination that the location of the router device corresponds to a first country, and selecting a second SIM in accordance with a determination that the location of the router device corresponds to a second country. In some examples, the method further comprises: monitoring a status of the first VPN or the second VPN; and based on the status of the first VPN or the second VPN, preventing the client device from communicating data via the Wi-Fi network or the cellular data network. In some examples, preventing the client device from communicating data via the Wi-Fi network or the cellular data network comprises one or more of: terminating one or more of the Wi-Fi network connection or the connection to the cellular data network, disconnecting the client device from the router device, and turning off the router device. In some examples, determining whether to establish a Wi-Fi network connection via the first wireless network interface comprises determining whether a public Wi-Fi access point is available. In some examples, the second wireless network interface comprises a wireless network interface of a mobile phone; the mobile phone comprises the one or more SIMs; and the method further comprises: in accordance with the determination not to establish a Wi-Fi network connection via the first wireless interface, establishing a connection between the router device and the mobile phone. In some examples, the one or more processors comprises a processor of the mobile phone. In some examples, the router device comprises a battery-powered mobile router device; the router device comprises the one or more sensors; the router device comprises the one or more processors; the router device is configured to present a graphical user interface via a display; and the one or more processors are configured to perform the method at least partially in response to user input received via the graphical user interface.

According to some examples of the disclosure, a method can comprise determining a location of a router device based on an output of one or more sensors, the router device in communication with a first wireless network interface; determining whether to establish a Wi-Fi network connection via the first wireless network interface; in accordance with a determination to establish a Wi-Fi network connection via the first wireless interface: selecting a Wi-Fi network based on the location of the router device; instantiating a first VPN via the Wi-Fi network; and communicating encrypted data from a client device to the first VPN via the Wi-Fi network; and in accordance with a determination not to establish a Wi-Fi network connection via the first wireless interface: selecting, based on the location of the router device, a SIM from one or more SIMs; initializing, based on the selected SIM, a connection to a cellular data network via a second wireless network interface; instantiating a second VPN via the cellular data network; and communicating encrypted data from the client device to the second VPN via the cellular data network. In some examples, selecting the SIM from the one or more SIMs is based on a bandwidth restriction associated with the location of the router device. In some examples, the selecting the SIM from the one or more SIMs is based on a data policy associated with the location of the router device. In some examples, the selecting the SIM from the one or more SIMs comprises selecting a first SIM in accordance with a determination that the location of the router device corresponds to a first country, and selecting a second SIM in accordance with a determination that the location of the router device corresponds to a second country. In some examples, the method further comprises: monitoring a status of the first VPN or the second VPN; and based on the status of the first VPN or the second VPN, preventing the client device from communicating data via the Wi-Fi network or the cellular data network. In some examples, preventing the client device from communicating data via the Wi-Fi network or the cellular data network comprises one or more of: terminating one or more of the Wi-Fi network connection or the connection to the cellular data network, disconnecting the client device from the router device, and turning off the router device. In some examples, determining whether to establish a Wi-Fi network connection via the first wireless network interface comprises determining whether a public Wi-Fi access point is available. In some examples, the second wireless network interface comprises a wireless network interface of a mobile phone; the mobile phone comprises the one or more SIMs; and the method further comprises: in accordance with the determination not to establish a Wi-Fi network connection via the first wireless interface, establishing a connection between the router device and the mobile phone. In some examples, the router device comprises a battery-powered mobile router device; the router device comprises the one or more sensors; the router device comprises the one or more processors; the router device is configured to present a graphical user interface via a display; and one or more steps of the method are performed at least partially in response to user input received via the graphical user interface.

According to some examples of the disclosure, a non-transitory computer-readable storage medium stores instructions which, when executed by one or more processors, cause the one or more processors to perform a method comprising: determining a location of a router device based on an output of one or more sensors, the router device in communication with a first wireless network interface; determining whether to establish a Wi-Fi network connection via the first wireless network interface; in accordance with a determination to establish a Wi-Fi network connection via the first wireless interface: selecting a Wi-Fi network based on the location of the router device; instantiating a first VPN via the Wi-Fi network; and communicating encrypted data from a client device to the first VPN via the Wi-Fi network; and in accordance with a determination not to establish a Wi-Fi network connection via the first wireless interface: selecting, based on the location of the router device, a SIM from one or more SIMs; initializing, based on the selected SIM, a connection to a cellular data network via a second wireless network interface; instantiating a second VPN via the cellular data network; and communicating encrypted data from the client device to the second VPN via the cellular data network. In some examples, selecting the SIM from the one or more SIMs is based on a bandwidth restriction associated with the location of the router device. In some examples, the selecting the SIM from the one or more SIMs is based on a data policy associated with the location of the router device. In some examples, the selecting the SIM from the one or more SIMs comprises selecting a first SIM in accordance with a determination that the location of the router device corresponds to a first country, and selecting a second SIM in accordance with a determination that the location of the router device corresponds to a second country. In some examples, the method further comprises: monitoring a status of the first VPN or the second VPN; and based on the status of the first VPN or the second VPN, preventing the client device from communicating data via the Wi-Fi network or the cellular data network. In some examples, preventing the client device from communicating data via the Wi-Fi network or the cellular data network comprises one or more of: terminating one or more of the Wi-Fi network connection or the connection to the cellular data network, disconnecting the client device from the router device, and turning off the router device. In some examples, determining whether to establish a Wi-Fi network connection via the first wireless network interface comprises determining whether a public Wi-Fi access point is available. In some examples, the second wireless network interface comprises a wireless network interface of a mobile phone; the mobile phone comprises the one or more SIMs; and the method further comprises: in accordance with the determination not to establish a Wi-Fi network connection via the first wireless interface, establishing a connection between the router device and the mobile phone. In some examples, the one or more processors comprises a processor of the mobile phone. In some examples, the router device comprises a battery-powered mobile router device; the router device comprises the one or more sensors; the router device comprises the one or more processors; the router device is configured to present a graphical user interface via a display; and one or more steps of the method are performed at least partially in response to user input received via the graphical user interface.

Although the present invention has been fully described in connection with examples thereof with reference to the accompanying drawings, it is to be noted that various changes and modifications will become apparent to those skilled in the art. Such changes and modifications are to be understood as being included within the scope of the claimed subject matter. The various examples of the invention should be understood that they have been presented by way of example only, and not by way of limitation. Although the invention is described above in terms of various examples and implementations, it should be understood that the various features and functionality described in one or more of the individual examples are not limited in their applicability to the particular example with which they are described. They instead can, be applied, alone or in some combination, to one or more of the other examples of the invention, whether or not such examples are described, and whether or not such features are presented as being a part of a described example. Thus the breadth and scope of the claimed subject matter should not be limited by any of the above-described examples.

Terms and phrases used in this document, and variations thereof, unless otherwise expressly stated, should be construed as open ended as opposed to limiting. As examples of the foregoing, the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known,” and terms of similar meaning, should not be construed as limiting the item described to a given time period, or to an item available as of a given time. These terms should instead be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. For example, “at least one” may refer to a single or plural and is not limited to either. The presence of broadening words and phrases such as “one or more,” “at least,” “but not limited to,” or other like phrases in some instances shall not be read to mean that the narrower case is intended or required in instances where such broadening phrases may be absent. The word “exemplary” is used herein to mean “serving as an example or illustration.” Any aspect or design described herein as “exemplary” is not necessarily to be construed as preferred or advantageous over other aspects or designs.

It will be appreciated that, for clarity purposes, the above description has described examples of the invention with reference to different functional units and modules. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization. It should be understood that the specific order or hierarchy of steps in the processes disclosed herein is an example of exemplary approaches. Based upon design preferences, it is understood that the specific order or hierarchy of steps in the processes may be rearranged while remaining within the scope of the claimed subject matter. Further, in some examples, some steps in the processes disclosed herein may be forgone altogether while remaining within the scope of the claimed subject matter.

What is claimed is:

1. A system comprising:
a router device in communication with a first wireless network interface;
one or more sensors; and
one or more processors configured to perform a method comprising:
determining, based on an output of the one or more sensors, a location of the router device;
determining whether to establish a Wi-Fi network connection via the first wireless network interface;
in accordance with a determination to establish a Wi-Fi network connection via the first wireless interface:
selecting a Wi-Fi network based on the location of the router device;
instantiating a first virtual private network (VPN) via the Wi-Fi network; and
communicating encrypted data from a client device to the first VPN via the Wi-Fi network; and
in accordance with a determination not to establish a Wi-Fi network connection via the first wireless interface:
selecting, based on the location of the router device, a SIM from one or more SIMs;
initializing, based on the selected SIM, a connection to a cellular data network via a second wireless network interface;
instantiating a second VPN via the cellular data network; and
communicating encrypted data from the client device to the second VPN via the cellular data network.

2. The system of claim 1, wherein the selecting the SIM from the one or more SIMs is based on a bandwidth restriction associated with the location of the router device.

3. The system of claim 1, wherein the selecting the SIM from the one or more SIMs is based on a data policy associated with the location of the router device.

4. The system of claim 1, wherein the selecting the SIM from the one or more SIMs comprises selecting a first SIM in accordance with a determination that the location of the router device corresponds to a first country, and selecting a second SIM in accordance with a determination that the location of the router device corresponds to a second country.

5. The system of claim 1, wherein the method further comprises:
monitoring a status of the first VPN or the second VPN; and
based on the status of the first VPN or the second VPN, preventing the client device from communicating data via the Wi-Fi network or the cellular data network.

6. The system of claim 5, wherein preventing the client device from communicating data via the Wi-Fi network or the cellular data network comprises one or more of: terminating one or more of the Wi-Fi network connection or the connection to the cellular data network, disconnecting the client device from the router device, and turning off the router device.

7. The system of claim 1, wherein determining whether to establish a Wi-Fi network connection via the first wireless network interface comprises determining whether a public Wi-Fi access point is available.

8. The system of claim 1, wherein:
the second wireless network interface comprises a wireless network interface of a mobile phone;
the mobile phone comprises the one or more SIMs; and
the method further comprises: in accordance with the determination not to establish a Wi-Fi network connection via the first wireless interface, establishing a connection between the router device and the mobile phone.

9. The system of claim 8, wherein the one or more processors comprises a processor of the mobile phone.

10. The system of claim 8, wherein:
the router device comprises a battery-powered mobile router device;
the router device comprises the one or more sensors;
the router device comprises the one or more processors;
the router device is configured to present a graphical user interface via a display; and
the one or more processors are configured to perform the method at least partially in response to user input received via the graphical user interface.

11. A method comprising:
determining a location of a router device based on an output of one or more sensors, the router device in communication with a first wireless network interface;
determining whether to establish a Wi-Fi network connection via the first wireless network interface;
in accordance with a determination to establish a Wi-Fi network connection via the first wireless interface:
selecting a Wi-Fi network based on the location of the router device;
instantiating a first VPN via the Wi-Fi network; and
communicating encrypted data from a client device to the first VPN via the Wi-Fi network; and
in accordance with a determination not to establish a Wi-Fi network connection via the first wireless interface:
selecting, based on the location of the router device, a SIM from one or more SIMs;
initializing, based on the selected SIM, a connection to a cellular data network via a second wireless network interface;
instantiating a second VPN via the cellular data network; and
communicating encrypted data from the client device to the second VPN via the cellular data network.

12. The method of claim 11, wherein the selecting the SIM from the one or more SIMs is based on a bandwidth restriction associated with the location of the router device.

13. The method of claim 11, wherein the selecting the SIM from the one or more SIMs is based on a data policy associated with the location of the router device.

14. The method of claim 11, wherein the selecting the SIM from the one or more SIMs comprises selecting a first SIM in accordance with a determination that the location of the router device corresponds to a first country, and selecting a second SIM in accordance with a determination that the location of the router device corresponds to a second country.

15. The method of claim 11, further comprising:
monitoring a status of the first VPN or the second VPN; and
based on the status of the first VPN or the second VPN, preventing the client device from communicating data via the Wi-Fi network or the cellular data network.

16. The method of claim 15, wherein preventing the client device from communicating data via the Wi-Fi network or the cellular data network comprises one or more of: terminating one or more of the Wi-Fi network connection or the connection to the cellular data network, disconnecting the client device from the router device, and turning off the router device.

17. The method of claim 11, wherein determining whether to establish a Wi-Fi network connection via the first wireless network interface comprises determining whether a public Wi-Fi access point is available.

18. The method of claim 11, wherein:
the second wireless network interface comprises a wireless network interface of a mobile phone;
the mobile phone comprises the one or more SIMs; and
the method further comprises: in accordance with the determination not to establish a Wi-Fi network connection via the first wireless interface, establishing a connection between the router device and the mobile phone.

19. A non-transitory computer-readable medium storing instructions which, when executed by one or more processors, cause the one or more processors to perform a method comprising:
determining a location of a router device based on an output of one or more sensors, the router device in communication with a first wireless network interface;
determining whether to establish a Wi-Fi network connection via the first wireless network interface;
in accordance with a determination to establish a Wi-Fi network connection via the first wireless interface:
selecting a Wi-Fi network based on the location of the router device;
instantiating a first VPN via the Wi-Fi network; and
communicating encrypted data from a client device to the first VPN via the Wi-Fi network; and
in accordance with a determination not to establish a Wi-Fi network connection via the first wireless interface:
selecting, based on the location of the router device, a SIM from one or more SIMs;
initializing, based on the selected SIM, a connection to a cellular data network via a second wireless network interface;
instantiating a second VPN via the cellular data network; and
communicating encrypted data from the client device to the second VPN via the cellular data network.

20. The non-transitory computer-readable medium of claim 19, wherein:
the second wireless network interface comprises a wireless network interface of a mobile phone;
the mobile phone comprises the one or more SIMs;
the method further comprises: in accordance with the determination not to establish a Wi-Fi network connection via the first wireless interface, establishing a connection between the router device and the mobile phone; and
the mobile phone comprises at least one processor of the one or more processors.
